(19) United States
(12) Patent Application Publication
(10) Pub. No.: US 2004/0247307 A1
(43) Pub. Date: Dec. 9, 2004

(54) Camera control device and digital still camera

(76) Inventor: Yoshio Serikawa, Kasukabe (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/859,090

(22) Filed: Jun. 3, 2004

(30) Foreign Application Priority Data
Jun. 5, 2003 (JP) JP 2003-161274
Apr. 22, 2004 (JP) JP 2004-126813

(51) Int. Cl. H04N 5/225; G03B 17/02; G03B 7/26

(52) U.S. Cl. 396/303; 348/372

(57) ABSTRACT

A digital still camera including a camera control device, which includes power supply monitoring means and power supply control means. The power supply monitoring means monitors a condition of a power source arranged in the digital still camera, and the power supply control means controls an electric current supply from the power source to a plurality of units in the digital still camera. The plurality of units are arranged to execute each function of the digital still camera. The power supply monitoring means includes a first determination means that determines whether the power source is in a state in which electric current can be supplied to the plurality of units simultaneously, based on a predetermined criterion. The power supply control means controls the supply of electric current to the plurality of units based on a result of a determination of the first determination means.

### BACKGROUND OF THE INVENTION

1. Field of the Invention

The present invention relates to a camera control device and to a digital still camera having the camera control device, and in particular to a camera control device that is able to execute a fast shutter release and to a digital still camera having the above-mentioned camera control device.

2. Description of the Related Art

A known digital still camera includes several units primarily driven with a battery as a power source. These units can include a stroboscope and a LCD monitoring display, for example. Consumption of the battery for operating the digital still camera must be suppressed as much as possible in order to achieve a long battery life. One prior art design suggests using a camera control device configured to permit a shutter release only after a stroboscope is fully charged, after which electricity is then solely supplied to an LCD monitor. In this way, power is supplied to only one of the stroboscope and the LCD monitor at any given time, thereby conserving battery power. Under such a configuration, however, there exists a problem that a chance for shooting could be missed if the charge-up time is long.

Also addressing the issue of conserving battery life is Japanese Patent Laid-Open No. 11-38471, which describes a camera having an LCD monitoring display and an optical finder, in which a back light of the LCD monitoring display is turned off when a user looks at a subject through the optical finder.

Similarly, Japanese Patent Laid-Open No. 2001-169167 proposes a method in which a processing time is shortened by means of timing adjustment or multiplexing of timing to output conversion data when converting an image data of a subject.

Also, Japanese Patent Laid-Open No. 2001-249381 describes a camera including a stroboscope and a shutter release switch that has two phases. Specifically, when charged voltage of the stroboscope reaches a predetermined level that could emit light when the shutter release switch is pushed down to the first phase, the camera stops charging and permits a shutter release. In this way, an image can be captured before the stroboscope is fully charged.

However, the above-described configurations do not optimally manage the supply of power from a power source to units of a digital camera and, consequently, opportunities for image capturing can be lost and/or battery power can be unnecessarily used.

### SUMMARY OF THE INVENTION

It is an object of the present invention to provide a camera control device, and a digital camera having the camera control device, that provides for shooting without missing a shooting chance, for controlling unnecessary electric current supplied to the monitoring display, and for extending battery life, by means of controlling a supply of electric current.

The present invention provides for a camera control device and a digital camera having the camera control device, which includes a power supply monitoring means and a power supply control means. The power supply monitoring means is configured to monitor a condition of a power source arranged in the digital still camera, while the power supply control means is configured to control the power source to supply electric current to a plurality of load circuit units.

The power source is detachably arranged in the digital camera in order to supply electric current to the units of the digital camera, including a camera control unit and load circuit units. The power source can be configured as a lithium ion battery, an alkaline (e.g., size AA) battery, or a dummy battery that is connected to AC power, for example. The camera control unit and load circuit units are arranged in the digital still camera to execute each function of the camera.

The load circuit includes, for example, an image input, an audio input, an operation member, a photometry input, a range-finding input, a monitoring display that displays a captured image, an external I/O, an audio output, a stroboscope, a status display, and a data storage. One aspect of the present invention is directed to a digital camera including both a stroboscope and a monitoring display in the digital camera. According to this aspect, the camera control device is arranged as a CPU and, therefore, the power supply monitoring means and the power supply control means correspond to the camera control device.

The power supply monitoring means includes a first determination means to determine whether the power source is in a state which can supply electric current to at least two of the load circuit units simultaneously. The determination of the first determination means is based on a predetermined criterion. The power supply control means controls the supply of electric current to the load circuit units based on the result of the determination of the first determination means.

In an aspect of the present invention, the first determination means determines a voltage of the power source and outputs a result of the determination based on the voltage measured. Also, because several types of power sources can be detachably arranged in the digital camera, the power supply monitoring means can monitor the attached power source and can output a result of the determination corresponding to the type of the attached power source.

In another aspect of the present invention, the first determination means refers to a first sub-criterion and a second sub-criterion. The first sub-criterion is used for determining when to supply electric current from the power source to the load circuit units. The second sub-criterion is used for determining when to prevent a supply of electric current to a unit, such the monitoring display, when electric current is supplied to another unit, such as the stroboscope. The first sub-criterion is set higher than the second sub-criterion.

In a further aspect of the present invention, the power supply monitoring means includes a second determination means for determining a charging condition of the stroboscope based on a predetermined criterion, and the power supply control means controls the supply of electric current from the power source to the monitoring display based on a result of a determination of the second determination means. The predetermined criterion of the second determination means can be a minimum voltage at which the stroboscope can emit light.

In another aspect of the present invention, the first determination means measures the voltage of the power source while supplying electric current to the displaying means before charging of the stroboscope is completed. The power supply control means interrupts the electric current supply from the power source to the monitoring display means when the measured voltage of the power source is less than a predetermined criterion, and controls resumption of the electric current supply from the power source to the monitoring displaying means when the charging of the stroboscope is completed. Namely, the charging of the stroboscope is interrupted when the voltage of the power source that is measured during charging becomes less than a predetermined voltage, and the electric current supply to the monitoring display is resumed after the charging of stroboscope is completed.

In a further aspect of the present invention, the predetermined criterion referred to by the second determination means is set at a particular voltage level such that the stroboscope will reach a full-charged voltage at the same time as when a predetermined stand-by time passes. The predetermined stand-by time is the time required to pass before the monitoring display can display an image after receiving electric current.

By using the various aspects of the present invention, a digital still camera can shoot without missing a shooting chance moreover, can control unnecessary supply of electric current to a monitoring display, and can extend battery life, by means of controlling the supply of electric current.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a digital still camera in accordance with an aspect of the present embodiment.

FIG. 2 is a block diagram illustrating the supply of electricity to elements of the digital still camera of FIG. 1.

FIG. 3 is a schematic representation of the power source switch of FIG. 2.

FIG. 4 is a schematic representation of the stroboscope of FIG. 1.

FIGS. 5a and 5b are a flow chart of the charging operation for the stroboscope of FIG. 1.

### DETAILED DESCRIPTION OF THE PREFERRED EMBODIMENTS

Referring now to the drawings, wherein like reference numerals designate identical or corresponding parts throughout the several views, a detailed description is made of the various aspects of the present invention. The above and further objects and novel features of the present invention will more fully appear from the following detailed description when the same is read in connection with the accompanying drawing. It is to be expressly understood, however, that the drawing are for purposes of illustration only and are not intended to define the limits of the present invention.

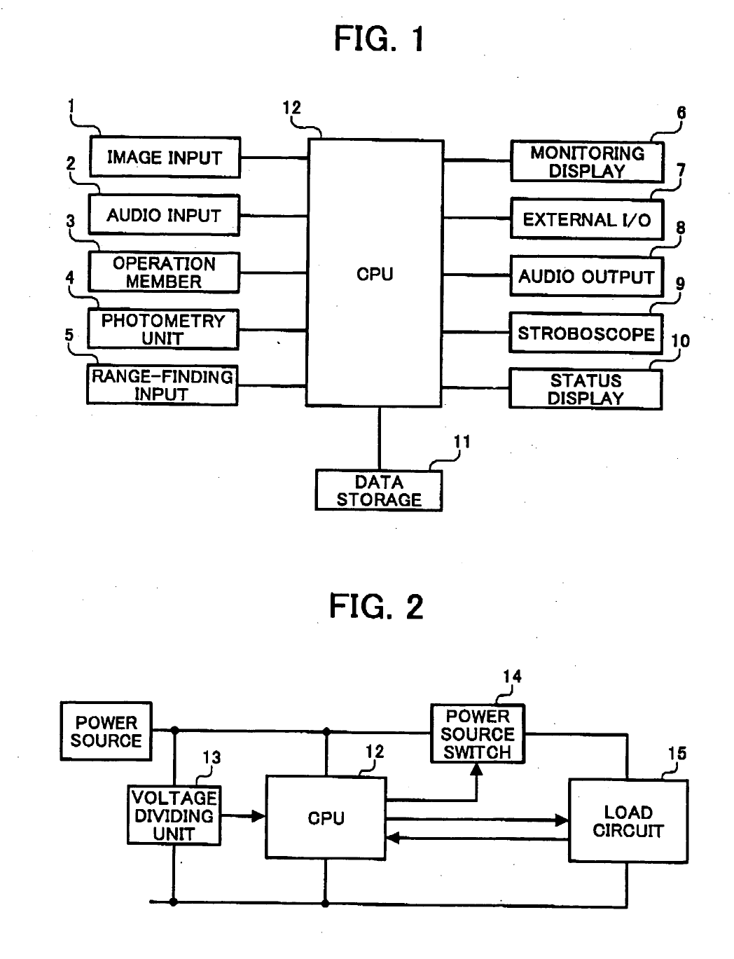

FIG. 1 is a block diagram of a digital still camera according to an aspect of the present invention. The digital still camera includes a camera control unit and a load circuit having a plurality of units, which are configured to perform functions of the camera. The load circuit includes an image input 1, an audio input 2, an operation member 3, a photometry input 4, a range-finding input 5, a monitoring display 6, an external I/O 7, an audio output 8, a stroboscope 9, a status display 10, and a data storage 11.

The camera control device is arranged as a CPU 12 and includes input/output ports communicatively connected to each of the load circuit units 1-11. The CPU 12 corresponds to a power supply monitoring means for monitoring a condition of a power source arranged in the digital still camera, and to a power supply control means for controlling a supply of electric current from the power source to the load circuit units 1-11. The CPU 12 can be configured as a conventional processing unit or, alternatively, as any other type of processing unit.

The image input 1 includes a shutter member, an optical lens, a focusing member, a diaphragm, the CCD, and an image input circuit (not shown). The image input 1 is configured to capture an optical image of a subject and to convert the optical image to an electric signal as an image data. The capture image data is processed in the CPU 12. The audio input 2 is configured to receive an audio signal from a microphone (not shown) and to send the audio signal to the CPU 12. The audio signal is processed in the CPU 12. The operation member 3 is configured to be operated by a user for setting an operation condition of the camera, such as shutter releasing, zooming, and data processing. The photometry input 4 is configured to input a condition of brightness. The range-finding input 5 is configured to input distance information to the subject. Either of the photometry input 4 or the range-finding input 5 can be omitted from the camera when the CCD is configured to receive brightness or distance information.

The monitoring display 6 is configured to display the image data processed in the CPU 12, and can be arranged as an LCD monitoring display, for example. The external I/O 7 is configured to communicate with an external apparatus such as a personal computer. The audio output 8 is configured to output the audio data as an audible sound. The stroboscope 9 includes a charging part and a light emission part 17 (FIG. 4). The emission of light at the stroboscope 9 is controlled by the CPU 12, which receives from the stroboscope 9 a charging voltage signal. The status display 10 is configured to display condition information such as an auto focus condition and a condition of the stroboscope 9. The data storage 11 is configured to store data for operation of the digital still camera, such as image data and audio data. The CPU 12 is configured to control an operation of above-mentioned plurality of units, including the image input 1, the audio input 2, the operation member 3, the photometry input 4, the range-finding input 5, the monitoring display the, an external I/O 7, the audio output 8, the stroboscope 9, the status display 10, and the data storage 11.

FIG. 2 is a block diagram illustrating the supply of electricity to each of the units 1-11 described above, collectively represented as a load circuit 15. The voltage-dividing unit 13 divides voltage of a power source to a predetermined voltage that is readable by the CPU 12, and the CPU 12 determines a condition of the power source based on the divided voltage by using an A/D converter function. Electric current is supplied to units of the load circuit 15 from the power source, and the electric current supply is controlled by the CPU 12 using a power source switch 14. The load circuit 15 can be configured such that power supplied to it is solely controlled by the CPU 12 and, in this case, the power source switch 14 is not necessary. Each unit of the load circuit 15 is controlled by an I/O signal from the CPU 12.

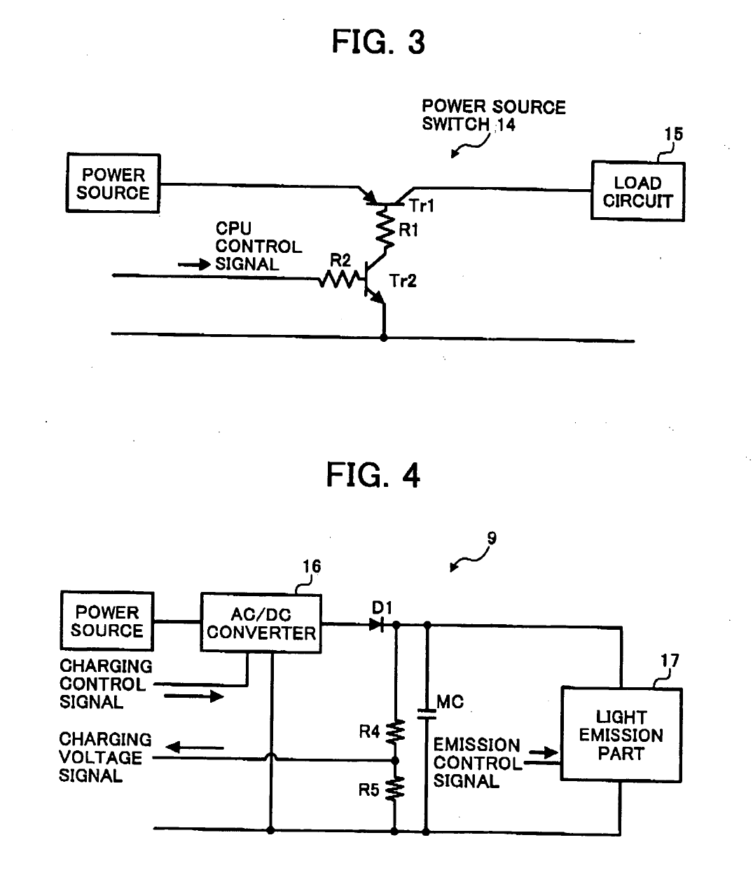

FIG. 3 is an example of a configuration of the power source switch 14. When a CPU control signal transmitted by the CPU 12 is a logic high, a transistor Tr2 is switched ‘ON’ and then a transistor Tr1 is switched ‘ON’ in sequence. As a result, electric current from the power source is supplied and controlled for the load circuit 15.

FIG. 4 is an example of a configuration of the stroboscope 9. The voltage of the power source is pulled up at the AC/DC converter 16 based on a charging control signal transmitted by the CPU 12. Subsequently, electric current is commutated at diode D1 and is charged to main capacitor MC. A charging voltage of the stroboscope 9 is pulled down at both a resistor R4 and a resistor R5 to a predetermined voltage that is readable by the CPU 12, and the pulled down voltage is sent back to the CPU 12. The CPU 12 estimates the charging voltage of the stroboscope with the pulled down voltage by means of an A/D converting function. The light emission part 17 is configured to selectively start and stop emission of light based on a light emission control signal transmitted from the CPU 12.

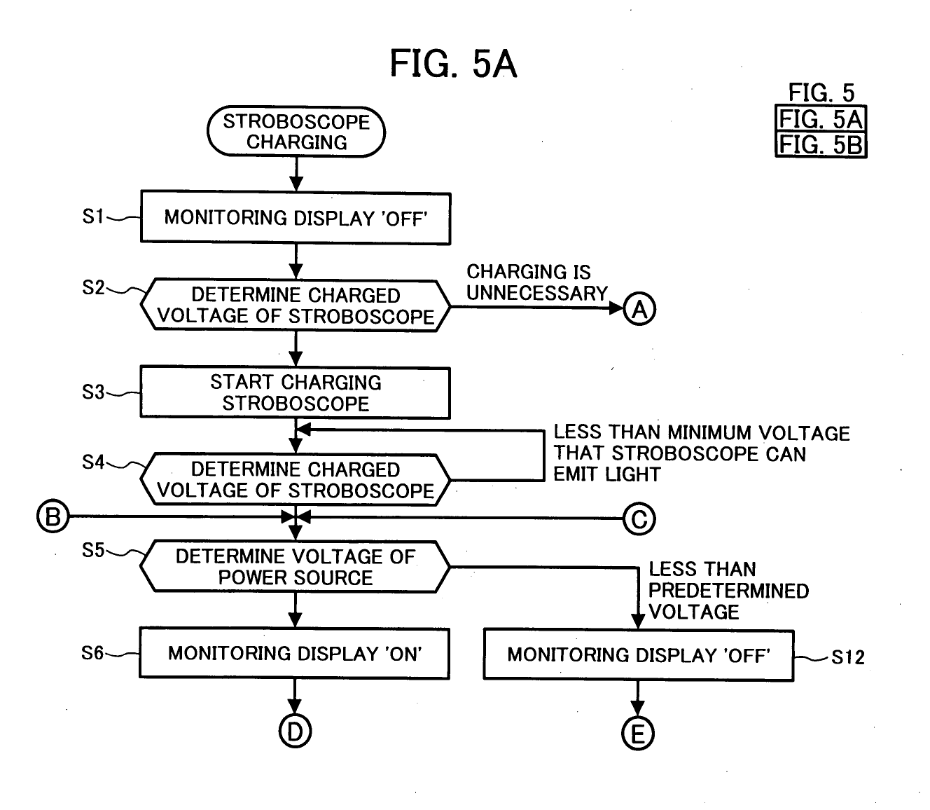

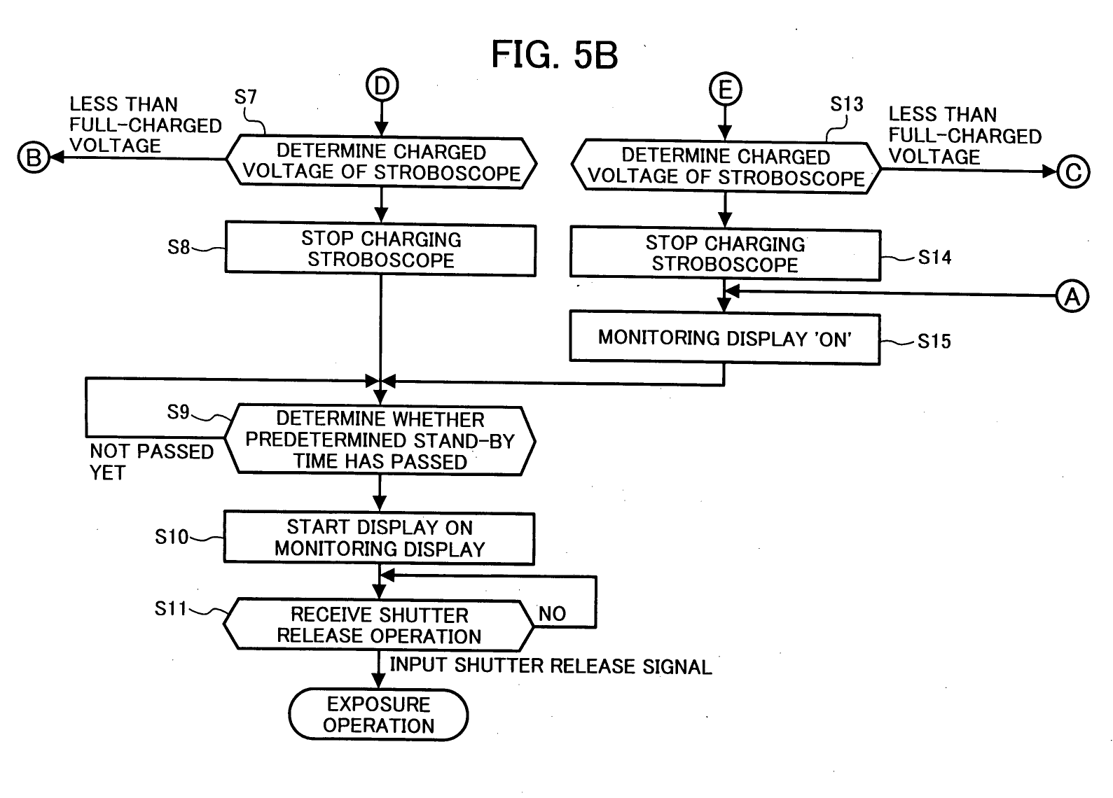

FIGS. 5a and 5b illustrate the steps of charging the stroboscope 9. At first, electric current is not supplied to the LCD monitoring display from the power source, such that the monitoring display is in an ‘OFF’ setting (step S1). Charging to the stroboscope 9 is determined to be necessary (step S2) if voltage charged currently in the stroboscope 9 is less than a predetermined minimum voltage necessary to emit light. When the present voltage of the stroboscope 9 is determined to be less than the predetermined minimum voltage, CPU 12 transmits the charging control signal to charge the stroboscope 9 and charging starts (step S3). The predetermined minimum voltage is a criterion set based on a minimum light volume from the light emission part 17 that is needed for shooting. Data representing the predetermined minimum voltage can be stored in a memory unit of the CPU 12 or in another memory unit of the digital still camera.

The CPU 12 monitors a charging voltage signal transmitted from the stroboscope 9, and when the charged voltage of the stroboscope reaches the minimum voltage to emit light (step S4), the CPU determines the voltage of the power source (step S5). The CPU 12 deems that the power source is in a state able to supply power to at least two of the units of the load circuit 15, e.g., the stroboscope 9 and the monitoring display 6, if the voltage of the power source is more than or equal to a predetermined criterion relating to the power source. Data representing this predetermined criterion can be stored in a memory unit located in the CPU 12 or in another memory unit of the digital still camera. When the voltage of the power source is greater than or equal to the predetermined criterion, the CPU 12 transmits a control signal to the power source switch 14 to allow a supply of electric current to the monitoring display 6. This supply of electric current switches the monitoring display 6 to an “ON” mode (step S6). The predetermined criterion is set higher than a voltage level at which the digital still camera will become unstable if the power source simultaneously supplies electric current to two load circuit units, such as the stroboscope 9 and the monitoring display 6. Step S6 also includes supplying power to the image input 1, which displays a monitoring image on the monitoring display 6.

Subsequently, the CPU 12 monitors the charging voltage of the stroboscope 9 by monitoring the pulled down voltage by means of an A/D converting function, and step S5 is repeated if the voltage of the stroboscope 9 is less than a full-charged voltage level (step S7). When the voltage of the stroboscope 9 reaches the full-charged voltage, charging is stopped (step S8), and the CPU 12 determines whether the predetermined stand-by time of the monitoring display 6 has passed (step S9). As discussed above, the monitoring display 6 is unable to display an image immediately upon receiving power (e.g., in step S6), and predetermined stand-by time represents the time period between the instance power is supplied to the monitoring display 6 to the instance the monitoring display 6 is able to display an image received from the image input 1. Data representing the predetermined stand-by time can be stored in a memory unit of the CPU 12 or in another memory unit of the digital still camera. If the predetermined stand-by time has passed, displaying on the monitoring display is started (step S10). At the same time, a shutter release operation is allowed (step S11), and an exposure operation will start if a shutter release signal is transmitted based on activation of the operation member 3 by a user.

If the voltage of the power source is determined to be less than the predetermined criterion in step S5, electric current continues to be withheld from the monitoring display 6 (step S12), and the CPU monitors the charging voltage of the stroboscope 9 by monitoring the pulled down voltage by means of the A/D converting function. Step S5 is repeated if it is determined that the voltage of the stroboscope 9 has not reached the full-charged voltage level (step S13). When the voltage of the stroboscope 9 reaches the full-charged voltage, charging is stopped (step S14), and the power source is allowed to supply electric current to the monitoring display 6 via the power source switch 14 (step S15). The process then proceeds to above-mentioned step S9. Processing in steps S13, S14 and S15 is similar to processing on step S7, S8 and S6, respectively.

While the stroboscope 9 is being charged in step S3, the user may mistakenly believe that the digital still camera is powered off because the monitoring display 6 is in an ‘OFF’ mode. Such a misunderstanding can be prevented by indicating a charging status during the stroboscope charging operation on a indication substitute means, such as a LED, and then by subsequently resuming displaying on the monitoring display.

Also, the digital still camera can control unnecessary electric current supplied to the monitoring display 6 by setting the predetermined criterion (i.e., the minimum voltage level of the stroboscope 9) referred to in step S4 of FIG. 5a to a particular voltage level that allows the stroboscope 9 to be fully-charged at the same time that the monitoring display 6 to ready to display an image (i.e., after the predetermined stand-by time passes). That is, referring to FIGS. 5a and 5b, the predetermined criterion can be selected such that step S8 or step S14 occur at the same time as step S10, thereby allowing a user to view an image on the monitoring display 6 at the exact moment that the stroboscope 9 is fully-charged.

Moreover, the digital still camera of the present invention can be configured to accommodate several types of power sources, e.g., lithium ion batteries, alkaline batteries, and dummy batteries connected to AC power. The digital still camera can also be configured to detect the type of power sources attached to the digital still camera by way of, for example, a mechanical sensor that transmits an identifying signal to the CPU 12. For finite-power sources, such as lithium ion or alkaline batteries, the digital still camera can efficiently manage battery life by monitoring the selected power source based on determination criterion corresponding to the type of power source and by controlling the supply of electric current according to the power source.

Alternative to the method described above, if the CPU 12 determines that the voltage of the power source is less than the predetermined criterion at step S5, the predetermined criterion may be set to have two values following this determination. The two values include a first sub-criterion used to determine when an electric current can be supplied to both the stroboscope 9 to charge and to the monitoring display 6, and a second sub-criterion used to determine when an electric current is to be withheld from the monitoring display 6 during charging the stroboscope 9. The first sub-criterion is set at a higher level than the second sub-criterion. In this manner, the digital still camera of the present invention can prevent unstable processing that may occur due to signal noise or an unexpected changing of the voltage of the power source.

The digital still camera of the present invention can perform the above-described functions with a simple composition and without the need for additional components. Obviously, numerous modifications and variations of the present invention are possible in light of the above teachings. It is therefore to be understood that within the scope of the appended claims, the invention may be practiced otherwise than as specifically described herein.

1. A camera control device comprising:
power supply monitoring means for monitoring a condition of a power source arranged in a digital still camera; and
power supply control means for controlling a supply of electric current from said power source to a plurality of units arranged in said digital still camera, wherein,
said power supply monitoring means includes first determination means for determining whether said power source is in a state in which said power source is able to supply electric current to at least two of the plurality of units simultaneously, said determining being based on a first predetermined criterion, and
said power supply control means controls the supply of electric current to at least one of said plurality of units based on a result of a determination of said first determination means.

2. The camera control device according to claim 1, wherein,
the power source is one of a plurality of types of power sources, and
said first determination means determines the state of the power source based on a type of the power source.

3. The camera control device according to claim 1, wherein,
said first predetermined criterion includes a first sub-criterion and a second sub-criterion,
said first sub-criterion is used to determine when electric current can be supplied from said power source to two of said plurality of units,
said second sub-criterion is used to determine when electric current is to be withheld from a first one of the plurality of units during a supply of electric current to a second one of the plurality of units, and
said first sub-criterion is a higher value than said second sub-criterion.

4. The camera control device according to claim 1, wherein said first determination means determines voltage of said power source and outputs a result of said determination based on said measured voltage.

5. The camera control device according to claim 1, wherein,
the plurality of units includes a stroboscope and a displaying means for displaying an image,
said power supply monitoring means includes second determination means for determining a charging condition of the stroboscope based on a second predetermined criterion, and
said power supply control means controls a supply of electric current from said power source to said displaying means based on a determination of said second determination means.

6. The camera control device according to claim 5, wherein,
said first determination means measures a voltage of said power source when a charging voltage of said stroboscope is equal to or greater than said second predetermined criterion and before charging of said stroboscope is completed,
said power supply control means allows electric current to be supplied from said power source to said displaying means when said voltage of said power source is equal to or greater than said first predetermined criterion, and
said power supply control means controls said displaying means to display said image after said displaying means reaches a state in which said displaying means is able to display said image and after charging of said stroboscope is completed.

7. The camera control device according to claim 5, wherein said second predetermined criterion is a minimum voltage level at which said stroboscope is able to emit light.

8. The camera control device according to claim 5, wherein,
said first determination means measures a voltage of said power source after said power source begins supplying electric current to said displaying means and before charging of said stroboscope is completed,
said power supply control means interrupts said supply of electric current from said power source to said displaying means when said voltage of said power source is less than said first predetermined criterion, and
said power supply control means controls resumption of said supply of electric current from said power source to said displaying means when said stroboscope is fully-charged.

9. The camera control device according to claim 5, wherein said second predetermined criterion is set at a voltage level such that said stroboscope will reach a full-charged level when a predetermined stand-by time period passes, said predetermined stand-by time period being a time period from an instance that said displaying means receives electric current from said power source to an instance that said displaying means is able to display said image.

10. A digital still camera comprising:
a plurality of load circuit units;
a power source configured to supply electric current to said plurality of load circuit units; and
a camera control device including,
power supply monitoring means for monitoring a condition of said power source, and
power supply control means for controlling a supply of electric current from said power source to said plurality of load circuit units arranged in said digital still camera, wherein,
said power supply monitoring means includes first determination means for determining whether said power source is in a state in which said power source is able to supply electric current to at least two of the plurality of load circuit units simultaneously, said determining being based on a first predetermined criterion, and
said power supply control means controls the supply of electric current to at least one of said plurality of load circuit units based on a result of a determination of said first determination means.

11. A camera control device comprising:
at least one input/output port communicatively connected to a plurality of units arranged in a digital still camera; and
a camera control unit configured to,
monitor a condition of a power source arranged in said digital still camera, said power source being configured to supply electric current to said plurality of units,
control a supply of electric current from said power source,
make a first determination, based on a first predetermined criterion, if said power source is in a state in which said power source is able to simultaneously supply electric current to at least two of said plurality of units,
output a result of said first determination, and
control said supply of electric current to at least one of said plurality of units based on said first determination.

12. The camera control device according to claim 11, wherein,
said digital still camera is configured to accommodate different types of power sources, and
said camera control unit is configured to output said result of said first determination based on a type of said power source.

13. The camera control device according to claim 11, wherein,
said camera control unit is configured to output said result of said first determination based on a first sub-criterion and a second sub-criterion,
said first sub-criterion is used to determine when electric current can be supplied from said power source to two of said plurality of units,
said second sub-criterion is used to determine when to prevent a supply of electric current to a first one of the plurality of units during a supply of electric current to a second one of the plurality of units, and
said first sub-criterion is set higher than said second sub-criterion.

14. The camera control device according to claim 11, wherein said camera control unit is configured to output said result of said first determination based on a measured voltage of said power source.

15. The camera control device according to claim 11, wherein,
the plurality of units includes a stroboscope and a monitoring display,
said camera control unit is configured to make a second determination based on a charging condition of the stroboscope and on a second predetermined criterion, and
said camera control unit is configured to control a supply of electric current to said monitoring display based on said second determination.

16. The camera control device according to claim 15, wherein,
said camera control unit is configured to measure a voltage of said power source when said second determination indicates that a voltage of said stroboscope is equal to or greater than the second predetermined criterion and before charging of said stroboscope is completed,
said camera control unit is configured to allow electric current to be supplied from said power source to said displaying means when said measured voltage of said power source is equal to or greater than said first predetermined criterion, and
said camera control unit is configured to control said monitoring display to display an image after said monitoring display reaches a state in which said monitoring display is able to display said image and after charging of said stroboscope is completed.

17. The camera control device according to claim 15, wherein said second predetermined criterion is a minimum voltage level at which said stroboscope is able to emit light.

18. The camera control device according to claim 15, wherein,
said camera control unit is configured to measure a voltage of said power source after said power source begins supplying electric current to said monitoring display and before charging of said stroboscope is completed,
said camera control unit is configured to interrupt the supply of electric current from said power source to said monitoring display when said measured voltage of said power source is less than the first predetermined criterion, and
said camera control unit is configured to control resumption of the supply of electric current from said power source to said monitoring display after charging of said stroboscope is completed.

19. The camera control device according to claim 15, wherein said second predetermined criterion is set at a voltage level such that charging of said stroboscope will be completed when a predetermined stand-by time period passes, said predetermined stand-by time period being a time period from an instance that said displaying means receives electric current from said power source to an instance that said displaying means is able to display said image.

20. A digital still camera comprising:
a stroboscope and a monitoring display;
a power source configured to supply electric current to said stroboscope and said monitoring display; and
a camera control unit configured to,
monitor a condition of said power source,
control a supply of electric current from said power source,
make a first determination, based on a first predetermined criterion, if said power source is in a state in which said power source is able to simultaneously supply electric current to said stroboscope and said monitoring display,
output a result of said first determination, and
control said supply of electric current to said stroboscope and said monitoring display based on said first determination.

21. A digital still camera comprising:
a plurality of units, each of said plurality of units configured to perform a function of said digital still camera;
a power source configured to supply electric current to said plurality of units; and
a camera control unit configured to,
monitor a condition of said power source,
control a supply of electric current from said power source,
make a first determination, based on a first predetermined criterion, if said power source is in a state in which said power source is able to simultaneously supply electric current to at least two of said plurality of units,
output a result of said first determination, and
control said supply of electric current to at least one of said plurality of units based on said first determination.

22. The digital still camera according to claim 21, wherein:
said digital still camera is configured to accommodate different types of power sources, and
said camera control unit is configured to output said result of said first determination based on a type of said power source.

23. A digital still camera according to claim 21, wherein,
said camera control unit is configured to output said result of said first determination based on a first sub-criterion and a second sub-criterion,
said first sub-criterion is used to determine when electric current can be supplied from said power source to two of said plurality of units,
said second sub-criterion is used to determine when to prevent a supply of electric current to a first one of the plurality of units during a supply of electric current to a second one of the plurality of units, and
said first sub-criterion is set higher than said second sub-criterion.

24. A digital still camera according to claim 21, wherein said camera control unit is configured to output said result of said first determination based on a measured voltage of said power source.

25. A digital still camera according to claim 21, wherein,
the plurality of units includes a stroboscope and a monitoring display,
said camera control unit is configured to make a second determination based on a charging condition of the stroboscope and on a second predetermined criterion, and
said camera control unit is configured to control a supply of electric current to said monitoring display based on said second determination.

26. A digital still camera according to claim 25, wherein,
said camera control unit is configured to measure a voltage of said power source when said second determination indicates that a voltage of said stroboscope is equal to or greater than the second predetermined criterion and before charging of said stroboscope is completed,
said camera control unit is configured to allow electric current to be supplied from said power source to said displaying means when said measured voltage of said power source is equal to or greater than said first predetermined criterion, and
said camera control unit is configured to control said monitoring display to display an image after said monitoring display reaches a state in which said monitoring display is able to display said image and after charging of said stroboscope is completed.

27. A digital still camera according to claim 25, wherein said second predetermined criterion is a minimum voltage level at which said stroboscope is able to emit light.

28. A digital still camera according to claim 25, wherein,
said camera control unit is configured to measure a voltage of said power source after said power source begins supplying electric current to said monitoring display and before charging of said stroboscope is completed,
said camera control unit is configured to interrupt the supply of electric current from said power source to said monitoring display when said measured voltage of said power source is less than the first predetermined criterion, and
said camera control unit is configured to control resumption of the supply of electric current from said power source to said monitoring display after charging of said stroboscope is completed.

29. A digital still camera according to claim 25, wherein said second predetermined criterion is set at a voltage level such that charging of said stroboscope will be completed when a predetermined stand-by time period passes, said predetermined stand-by time period being a time period from an instance that said displaying means receives electric current from said power source to an instance that said displaying means is able to display said image.

30. A method for controlling a digital still camera including a power source and a plurality of units, comprising:
monitoring a condition of said power source;
determining, as a first determination and based on a first predetermined criterion, whether said power source is in a state in which said power source is able to supply electric current to at least two of said plurality of units simultaneously; and
controlling said power source to supply electric current to said plurality of units based on said first determination.

31. The method for controlling a digital still camera according to claim 30, further comprising:
detecting a type of said power source, which is selected from a plurality of types of detachable power sources;
setting said first predetermined criterion based on said detected type of said power source.

32. The method for controlling a digital still camera according to claim 30, further comprising:
storing said first predetermined criterion in said digital still camera, said first predetermined criterion including a first sub-criterion and a second sub-criterion;
referring to said first sub-criterion to determine when electric current can be supplied from said power source to two of said plurality of units;
referring to said second sub-criterion to determine when electric current is to be withheld from a first one of the plurality of units during a supply of electric current to a second one of the plurality of units; and
setting said first sub-criterion at a higher value than said second sub-criterion.

33. The method for controlling a digital still camera according to claim 30, comprising:
determining said first determination based on a measured voltage of said power source.

34. The method for controlling a digital still camera according to claim 30, comprising:
determining, as a second determination and based on a second predetermined criterion, a charging condition of a stroboscope arranged in said digital still camera; and
controlling, based on said second determination, a supply of electric current from said power source to a monitoring display arranged in said digital still camera.

35. The method for controlling a digital still camera according to claim 34, comprising:
measuring a voltage of said power source when a voltage of said stroboscope is equal to or greater than a second predetermined criterion and before charging of said stroboscope is completed;
allowing electric current to be supplied to said displaying means when said measured voltage of said power source is equal to or greater than a predetermined criterion; and
controlling said monitoring display to display an image after said monitoring display reaches a state in which said monitoring display is able to display said image and after charging of said stroboscope is completed.

36. The method for controlling a digital still camera according to claim 34, comprising:
setting said second predetermined criterion to a minimum voltage level at which said stroboscope is able to emit light.

37. The method for controlling a digital still camera according to claim 34, comprising:
measuring a voltage of said power source after said power source begins supplying electric current to said monitoring display and before charging of said stroboscope is completed;
interrupting a supply of electric current from said power source to said monitoring display when said measured voltage of said power source is less than the first predetermined criterion; and
allowing said supply of electric current from said power source to said monitoring display when charging of said stroboscope is completed.

38. The method for controlling a digital still camera according to claim 34, comprising:
setting said second predetermined criterion to a voltage level such that charging of said stroboscope will be completed when a predetermined stand-by time period passes, said predetermined stand-by time period being a time period from an instance that said displaying means receives electric current from said power source to an instance that said displaying means is able to display said image.
